(19) United States
(12) Patent Application Publication
(10) Pub. No.: US 2014/0069869 A1
(43) Pub. Date: Mar. 13, 2014

(54) CROSS FLOW FILTRATION SYSTEM USING ATMOSPHERIC BLADDER TANK

(71) Applicant: 3M INNOVATIVE PROPERTIES COMPANY, St. Paul, MN (US)

(72) Inventors: Hemang R. Patel, Middletown, CT (US); Robert E. Astle, Middlefield, CT (US); Martin J. Blaze, Hamden, CT (US); Laurence W. Bassett, Killingworth, CT (US)

(73) Assignee: 3M INNOVATIVE PROPERTIES COMPANY, St.Paul, MN (US)

(21) Appl. No.: 14/116,161

(22) PCT Filed: May 3, 2012
(86) PCT No.: PCT/US2012/036316

§ 371 Date: Nov. 7, 2013

Related U.S. Application Data
(60) Provisional application No. 61/485,937, filed on May 13, 2011.

(51) Int. Cl. C02F 1/44

(52) U.S. Cl. CPC C02F 1/441
USPC 210/650; 210/257.2

(57) ABSTRACT

A fluid treatment system is disclosed comprising a cross flow filter (110) comprising a feed portion, a concentrate portion, and a permeate portion. The treatment system further comprises a permeate storage apparatus (130) fluidly connected to the permeate portion and comprising a pressure boundary comprising an inner wall surrounding a pliable bladder (150), the pliable bladder fluidly separating a permeate chamber from an atmospheric chamber (170). The treatment system may further comprise a permeate pressurizing device (180) fluidly connecting the permeate chamber to a system output.

### BACKGROUND

In cross flow filtration systems, a feed fluid can be purified by application of pressure across a membrane such that purified fluid is forced through the membrane (i.e., the permeate) and impurities are concentrated on the upstream side of the membrane (i.e., the concentrate). Often, the concentrate is flushed away from the upstream side of the membrane and plumbed to a drain. The permeate can be delivered to an output such as a faucet for consumption or other use.

The production rate of permeate in such systems tends to be somewhat limited. For example, in the case of reverse osmosis drinking water systems, the continuous permeate flow rate across a membrane may be less than the desired flow rate from a downstream faucet. To mitigate this problem, hydropneumatic storage tanks may be used to accumulate a ready supply of permeate. Hydropneumatic tanks typically rely upon a pre-charge of compressed air to supply driving force to the stored permeate. As the amount of permeate in the tank increases, the air is further compressed, thus providing greater force to push the permeate to a faucet or other output.

In order to continue efficiently producing permeate, such systems rely upon sufficient differential pressure across the membrane. If the differential pressure is inadequate, efficiency and permeate quality can decline. Eventually, production of permeate can cease altogether. When hydropneumatic tanks are used as described above, the permeate pressure will rise as the air in the tank is compressed. This rise in permeate pressure can cause backpressure on the membrane. This backpressure can reduce differential pressure across the membrane, thereby decreasing permeate production.

There is a need for improved cross flow filtration systems.

### SUMMARY OF THE INVENTION

The present disclosure provides fluid treatment systems and methods of treating, producing, and storing permeate that can advantageously provide increased permeate capacity for downstream use while avoiding backpressure on the permeate portion of a cross flow filter and avoiding contamination of stored permeate from airborne or other contaminants. In doing so, disclosed systems can increase production efficiency and quality in cross flow filters and filtration systems. Systems and methods according to the present disclosure can provide benefits described above while also providing the ability to effectively store large quantities of permeate that may have considerable weight and gravity-induced pressures within the storage tank.

In a first embodiment, the present disclosure provides a fluid treatment system comprising: a cross flow filter comprising a feed portion, a concentrate portion, and a permeate portion; a permeate storage apparatus fluidly connected to the permeate portion and comprising: a pressure boundary comprising an inner wall surrounding a pliable bladder, the pliable bladder fluidly separating a permeate chamber from an atmospheric chamber; and a permeate pressurizing device fluidly connecting the permeate chamber to a system output.

In a second embodiment, the present disclosure provides the the first embodiment wherein the atmospheric portion communicates with a surrounding atmosphere via an aperture in the pressure boundary.

In a third embodiment, the present disclosure provides the first or second embodiments further comprising a pressure switch fluidly connected to one of the permeate portion or the permeate chamber to monitor a permeate pressure, the pressure switch operable to disrupt a fluid flow to the feed portion when the permeate pressure exceeds a permeate pressure setpoint.

In a fourth embodiment, the present disclosure provides the any of the first through third embodiments wherein the permeate chamber comprises the inner wall.

In a fifth embodiment, the present disclosure provides any of the first through fourth embodiments wherein the atmospheric chamber does not comprise the inner wall.

In a sixth embodiment, the present disclosure provides any of the first through fifth embodiments wherein the pressure boundary is designed to withstand a constant fluid pressure of at least 30 psi (2.07e+005 N/m²) bearing against the inner wall.

In a seventh embodiment, the present disclosure provides any of the first through sixth embodiments wherein the inner wall is smooth.

In an eight embodiment, the present disclosure provides any of the first through seventh embodiments wherein the pressure boundary comprises a cylindrical portion.

In a ninth embodiment, the present disclosure provides a method of storing a permeate in a permeate storage apparatus comprising a pressure boundary comprising an inner wall surrounding a pliable bladder, the pliable bladder fluidly separating a permeate chamber from an atmospheric chamber, the method comprising: applying a differential pressure across the pliable bladder to expand the pliable bladder against the inner wall and purge the permeate chamber of fluid; introducing a permeate into the purged permeate chamber; and after introducing the permeate, allowing the atmospheric chamber and the permeate chamber to reach the pressure of a surrounding atmosphere.

In a tenth embodiment, the present disclosure provides the ninth embodiment wherein applying a differential pressure across the pliable bladder comprises applying elevated pressure to the atmospheric chamber.

In an eleventh embodiment, the present disclosure provides the tenth embodiment wherein applying elevated pressure to the atmospheric chamber comprises charging the atmospheric chamber via a charging valve.

In a twelfth embodiment, the present disclosure provides the tenth or eleventh embodiments wherein allowing the atmospheric chamber and the permeate chamber to reach the pressure of a surrounding atmosphere comprises releasing the elevated pressure from the atmospheric chamber.

In a thirteenth embodiment, the present disclosure provides the twelfth embodiment wherein releasing the elevated pressure from the atmospheric chamber comprises actuating a toggle valve.

In a fourteenth embodiment, the present disclosure provides the ninth embodiment wherein applying a differential pressure across the pliable bladder comprises applying suction to the permeate chamber.

In a fifteenth embodiment, the present disclosure provides the fourteenth embodiment wherein applying suction to the permeate chamber comprises pulling on the permeate chamber with a permeate pressurizing device.

In a sixteenth embodiment, the present disclosure provides the ninth through fifteenth embodiments further comprising, prior to introducing a permeate into the purged permeate chamber, fluidly connecting the purged permeate chamber to permeate plumbing including a permeate portion of a cross flow filter.

In a seventeenth embodiment, the present disclosure provides the ninth through sixteenth embodiments further comprising, prior to introducing a permeate into the purged permeate chamber, fluidly connecting the purged permeate chamber to permeate plumbing including a permeate pressurizing device.

In an eighteenth embodiment, the present disclosure provides a method of producing a permeate comprising: producing a permeate using a cross flow filter comprising a feed portion, a concentrate portion, and a permeate portion; introducing the permeate from the permeate portion into a permeate storage apparatus comprising a pressure boundary comprising an inner wall surrounding a pliable bladder, the pliable bladder fluidly separating a permeate chamber from an atmospheric chamber; and as the permeate chamber expands from introduction of permeate, allowing the atmospheric chamber to fluidly communicate with a surrounding atmosphere as it contracts to avoid generating back pressure against the permeate portion of the cross flow filter.

In a nineteenth embodiment, the present disclosure provides the eighteenth embodiment further comprising delivering permeate from the permeate chamber to a system output.

In a twentieth embodiment, the present disclosure provides the nineteenth embodiment further comprising: as the permeate chamber contracts from delivery of permeate, allowing the atmospheric chamber to fluidly communicate with a surrounding atmosphere as it expands to avoid reducing the pressure in the atmospheric chamber.

Unless otherwise specified, “atmospheric chamber” as used herein means a chamber in a permeate storage apparatus containing a fluid (either a gas or a liquid) whose pressure remains in substantial equilibrium with the pressure of the atmosphere surrounding the permeate storage apparatus regardless of whether the permeate storage apparatus is filling with permeate, is in a steady state, or is discharging permeate.

These and other aspects of the invention will be apparent from the detailed description below. In no event, however, should the above summaries be construed as limitations on the claimed subject matter, which subject matter is defined solely by the attached claims, as may be amended during prosecution.

### BRIEF DESCRIPTION OF THE DRAWINGS

Throughout the specification, reference is made to the appended drawings, where like reference numerals designate like elements, and wherein:

FIG. 1 is a schematic view of an exemplary fluid treatment system according to the present disclosure;

FIG. 2A is a schematic view of an exemplary permeate storage apparatus according to the present disclosure wherein fluid is purged from the permeate portion;

FIG. 2B is a schematic view of an exemplary permeate storage apparatus according to the present disclosure wherein permeate is filling the permeate portion;

FIG. 2C is a schematic view of an exemplary permeate storage apparatus according to the present disclosure wherein permeate is being discharged from the permeate portion; and

FIG. 3 is a partial schematic view of an exemplary permeate storage apparatus according to the present disclosure comprising a toggle valve in conjunction with a charging valve.

### DETAILED DESCRIPTION OF THE DRAWINGS

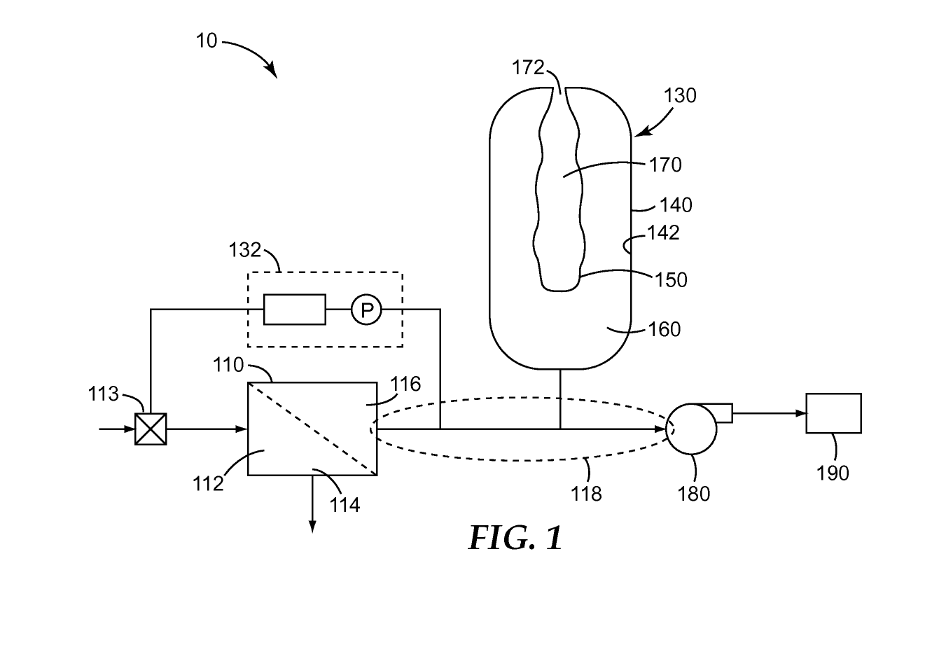

As shown in FIG. 1, fluid treatment systems according to the present disclosure can comprise a cross flow filter 110 comprising a feed portion 112, a concentrate portion 114, and a permeate portion 116. As depicted, the permeate portion 116 is plumbed directly to a permeate storage apparatus 130 such that permeate leaving the cross flow filter 110 can enter and fill a permeate chamber 160 of a permeate storage apparatus 130. Often, the concentrate portion 114 is plumbed through a flow restrictor to a drain. Any form of cross flow filter 110 element or module, e.g., reverse osmosis, may be employed within the scope of the present disclosure. It is also envisioned that multiple cross flow filters may be employed in the same system, depending on requirements for a given application.

When permeate is called for, a permeate pressurizing device 180 can deliver permeate from the permeate chamber 160 to a system output 190. In one embodiment, the permeate pressurizing device 180 comprises an electric pump. However, the permeate pressurizing device 180 may comprise any device or configuration, including the application of gravity, capable of generating a pressure head to deliver permeate from the permeate chamber 160 (at a lower pressure) to the system output 190. The system output 190 may comprise, for example, a faucet, a tap, a nozzle, or simply downstream plumbing, so long as it is a location or device where permeate is delivered.

As depicted, the permeate storage apparatus 130 comprises a pliable bladder 150. The pliable bladder 150 is surrounded by the inner wall 142 of a pressure boundary 140 and separates a permeate chamber 160 from an atmospheric chamber 170. As shown in this embodiment, pliable bladder 150 is a bag-type bladder having a small opening at one end in fluid communication with an aperture 172 in the pressure boundary 140. The pliable bladder 150 is capable of expanding and contracting with an inconsequential effect on the pressure of the permeate in the permeate chamber 160. The atmospheric chamber 170 is shown “inside” the pliable bladder 150 such that a fluid inside the atmospheric chamber 170 is in fluid communication with the surrounding atmosphere 2 and does not come into direct contact with the inner wall 142 of the pressure boundary 140. In such embodiments, the permeate chamber 160 may surround the atmospheric chamber 170. In some such embodiments, virtually the entire inner wall 142 is available for direct contact with permeate or pliable bladder 150. In similar embodiments, only a portion of the inner wall 142 may be available for direct contact with permeate or pliable bladder 150, while the remainder may be available for direct contact with the fluid in the atmospheric chamber 170.

Typically, the pliable bladder 150 is constructed of a material that is impervious to fluid such that there is no fluid communication between the permeate portion 116 and the atmospheric portion. It is to be understood, however, that a certain level of insubstantial fluid communication across the pliable bladder 150, such as by slow diffusion of a gas through the pliable bladder 150, may not affect proper steady-state operation of the system and thus may be tolerated. Possible materials for the pliable bladder 150 include, for example, elastomers and composites of elastomers and other materials to alter strength, elasticity, or permeability.

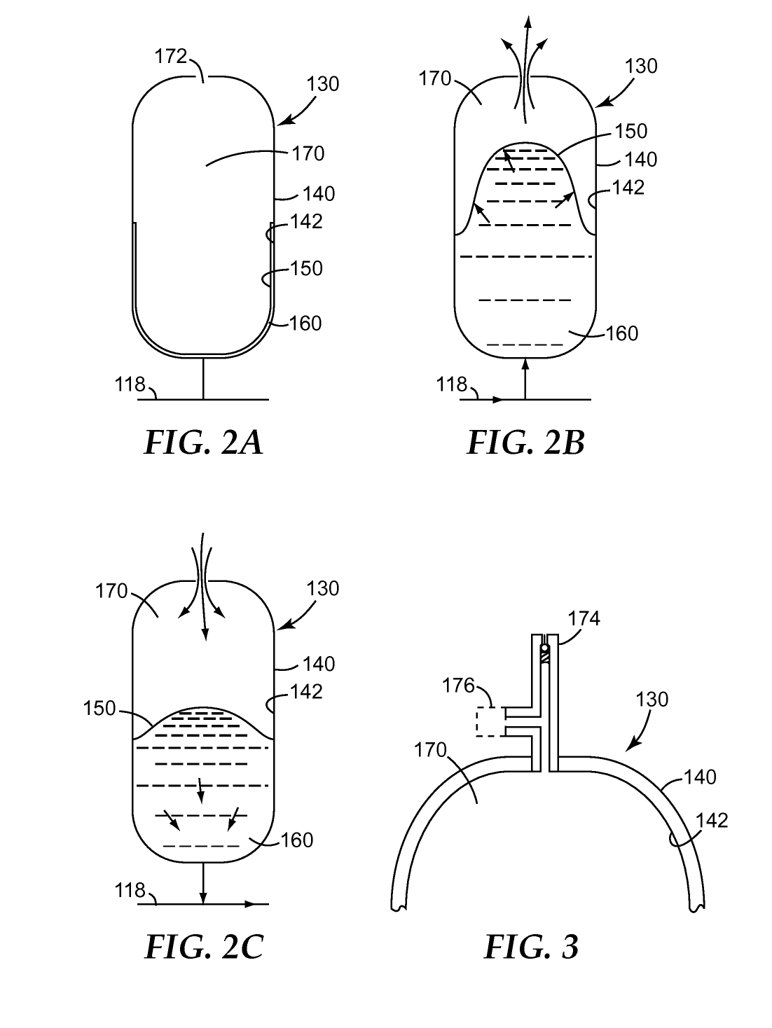

When the permeate chamber 160 is purged of all permeate, and as long as the permeate circuit is closed, the pliable bladder 150 will expand to bear directly against the inner wall 142 of the pressure boundary 140. As the permeate chamber 160 fills with permeate, the pliable bladder 150 (and the atmospheric chamber 170) will contract in response. As depicted, for example, in FIGS. 2A-2C, during purge, fill, or rest, the pliable bladder 150 preferably prevents air or other substances from entering the permeate chamber 160, thus helping to prevent contamination of the permeate. Moreover, under typical operating conditions, both the permeate chamber 160 and atmospheric chamber 170 will be at the pressure of the surrounding atmosphere during purge, fill, or rest.

However, a possible exception may occur when the permeate chamber 160 is filled to capacity with permeate such that the atmospheric chamber 170 is completely collapsed and the permeate bears completely against the inner wall 142 of the pressure boundary 140. Under such conditions, because the permeate is typically an incompressible fluid, its pressure will begin to very rapidly rise. If permeate production is not ceased under such conditions, the permeate pressure will quickly rise to the pressure of the feed fluid and the differential pressure across the cross flow membrane will go to zero. In one embodiment, a pressure switch 132 is optionally provided to monitor permeate pressure in the permeate storage plumbing 118 such that a feed flow into the cross flow filter 110 can be selectively stopped when the permeate pressure begins to rise above the pressure of the surrounding atmosphere. In some instances, the pressure switch 132 communicates with a feed valve 113 to selectively open or close the feed flow. Feed valve may comprise any type of fluid valve suitable for opening and closing the feed flow, such as for example, faucet valves, gate valves, ball valves, solenoid valves, and the like. Preferably, the feed valve is automatically actuated in response to a signal form the pressure switch.

Because the pressure boundary 140 is configured to withstand significant permeate pressures, the pressure boundary 140 can provide an advantageous redundancy against omission, potential failure, or improper configuration of a pressure switch 132. In other words, should the pressure switch 132 fail or be omitted, the pressure boundary 140 can withstand the rise of the permeate pressure to feed fluid pressure while mitigating risk of rupture. The feed fluid pressure may be, for example, typical service line pressure for city or well water service. In one embodiment, the pressure vessel is configured to withstand a continuous typical United States residential and commercial municipal service line pressure. In some embodiments, the pressure vessel is configured to withstand a continuous permeate pressure bearing against the inner wall 142 of greater than about 30 psi (about 2.07e+005 N/m²), more preferably greater than about 60 psi (about 4.14e+005 N/m²), and still more preferably greater than about 100 psi (about 6.89e+005 N/m²), 125 psi (8.62e+005 N/m²), or 200 psi (1.38e+006 N/m²).

It is envisioned that permeate storage apparatus 130 according to the present disclosure may include pressure vessels having a volume capacity in a range from about 0.026 gallons (about 100 milliliters), 0.132 gallons (500 milliliters), 0.16 gallons (605 milliliters), 0.5 gallons (1.89 liters), 1 gallon (about 3.79 liters) to greater than 1,000 gallons (3.79e+003 liters), including about 2 gallons (about 7.57 liters), 4 gallons (15.1 liters), 8 gallons (30.3 liters), 16 gallons (60.6 liters), 32 gallons (121 liters), 44 gallons (167 liters), 60 gallons (227 liters), 120 gallons (454 liters), 250 gallons (946 liters), and 500 gallons (1.89e+003 liters). As pressure vessels become larger, the weight of stored permeate increases proportionally and may become substantial. For example, because water weighs about 8.35 pounds (about 3.79 kilograms) per gallon, a 60 gallon (227 liters) pressure vessel filled to capacity with water as permeate will contain about 500 pounds (about 227 kilograms) of water. In such embodiments, it is important that the permeate storage apparatus 130 be a strong pressure boundary 140 as disclosed so that permeate may be safely and reliably stored.

So that the pliable bladder 150 can bear against the inner wall 142 of the pressure boundary 140 without damage (e.g., by abrasion or poking holes in the bladder), the portion of the inner wall 142 that may contact the pliable bladder 150 is typically smooth and free of interruption by protrusions such as plumbing or support structure. In one embodiment, the inner wall 142 comprises a major surface and is free of features protruding more than 0.5 inches (1.27 centimeters) inwardly from the major surface. More preferably, the inner wall 142 is free of features protruding more than 0.25 inches (0.635 centimeter), 0.125 inches (0.318 centimeter), or even 0.05 inches (0.127 centimeter) inwardly from the major surface. In some embodiments, the pressure boundary 140 is primarily cylindrical in cross section. In some embodiments, the pressure boundary 140 comprises a cylindrical tank having substantially hemispherical ends. In some embodiments, the pressure boundary 140 comprises a cylindrical tank wherein the inner wall 142 comprises a minimum radius in a range from about 1 inch (about 2.54 centimeters) to about 12 inches (about 30.5 centimeters), including 2 inches (5.08 centimeters), 3 inches (7.62 centimeters), 4 inches (10.2 centimeters), 5 inches (12.7 centimeters), 6 inches (15.2 centimeters), 7 inches (17.8 centimeters), 8 inches (20.3 centimeters), 9 inches (22.9 centimeters), 10 inches (25.4 centimeters), and 11 inches (27.9 centimeters).

In order to ensure that the permeate chamber 160 remains substantially free of air or other substances, it may be advantageous to assemble and initiate operation of disclosed treatment systems in a particular manner. For example, it may be advantageous to first purge the permeate chamber 160 of gas by temporarily charging the atmospheric chamber 170 with a pressurized fluid, thus expanding the pliable bladder 150 and forcing fluid out of the permeate chamber 160, as depicted in FIG. 2A. A typical charge may comprise air at a pressure in a range from about 3-30 psi (about 2.07e+004-2.07e+005 N/m²), including about 7 psi (about 4.83e+004 N/m²), above the pressure of the surrounding atmosphere. The purged permeate chamber 160 can then be connected and sealed to the permeate plumbing 118 on the treatment system. It should be noted that, while a simplified permeate plumbing 118 system is depicted in FIG. 1, numerous other plumbing options are envisioned within the scope of the present disclosure. Then, the charge in the atmospheric chamber 170 can be released, and permeate allowed to begin filling the permeate chamber 160, as depicted in FIG. 2B. Because the sealed permeate plumbing will be a closed system, no air or other substances should be permitted to enter the permeate plumbing as the pliable bladder 150 expands and contracts with varying levels of permeate, as depicted in FIGS. 2B and 2C.

In order to carry out the pre-charging process as described above, it may be advantageous to include a charging valve 174, such as a Schrader valve or other check valve, in communication with the atmospheric chamber 170 through an aperture 172 the inner wall 142 of the pressure boundary 140. After charging, and upon successful connection of the permeate chamber 160 to associate permeate plumbing, the charging valve 174 can be removed to allow the atmospheric chamber 170 to settle to the pressure of the surrounding atmosphere.

Alternatively, a toggle valve 176 in fluid communication with the atmospheric chamber 170 may be included in addition to the charging valve 174, as depicted in FIG. 3. As used herein, “toggle valve 176” means a valve configured to selectively open or close a fluid conduit, and includes, for example, faucet valves, gate valves, ball valves, solenoid valves, and the like. In such embodiments, the toggle valve 176 can remain closed to hold a pre-charge in the atmospheric chamber 170, and can be opened to defeat the charging valve 174 and permit settling to the pressure of the surrounding atmosphere. In such embodiments, the charging valve 174 need not be removed. It is envisioned that such toggle valve 176 may be provided separately from the charging valve 174, or may be interposed between the charging valve 174 and the atmospheric chamber 170.

Various modifications and alterations of the invention will be apparent to those skilled in the art without departing from the spirit and scope of the invention. It should be understood that the invention is not limited to illustrative embodiments set forth herein.

1. A fluid treatment system comprising:
a cross flow filter comprising a feed portion, a concentrate portion, and a permeate portion;
a permeate storage apparatus fluidly connected to the permeate portion and comprising:
a pressure boundary comprising an inner wall surrounding a pliable bladder, the pliable bladder fluidly separating a permeate chamber from an atmospheric chamber which communicates with the surrounding atmosphere via an aperture in the pressure boundary such that the pressure in the atmospheric chamber remains in substantial equilibrium with the pressure of the surrounding atmosphere; and
a permeate pressurizing device fluidly connected between the permeate chamber and a system output.

2. The fluid treatment system of claim 1 further comprising a pressure switch fluidly connected to one of the permeate portion or the permeate chamber to monitor a permeate pressure, the pressure switch operable to disrupt a fluid flow to the feed portion when the permeate pressure exceeds a permeate pressure setpoint.

3. The fluid treatment system of claim 1 wherein the permeate chamber comprises the inner wall.

4. The fluid treatment system of claim 1 wherein the atmospheric chamber does not comprise the inner wall.

5. The fluid treatment system of claim 1 wherein the pressure boundary is designed to withstand a constant fluid pressure of at least 30 psi (2.07e+005 N/m²) bearing against the inner wall.

6. The fluid treatment system of claim 1 wherein the inner wall is smooth.

7. The fluid treatment system of claim 1 wherein the pressure boundary comprises a cylindrical portion.

8. A method of assembling and initiating operation of the fluid treatment system of claim 1, the method comprising:
applying a differential pressure across the pliable bladder to expand the pliable bladder against the inner wall and purge the permeate chamber substantially free of fluid;
fluidly connecting the purged permeate chamber to permeate plumbing including a permeate portion of a cross flow filter and a permeate pressurizing device;
allowing the atmospheric chamber to settle to the pressure of the surrounding atmosphere via an aperture in the pressure boundary;
introducing a permeate into the purged permeate chamber; and
allowing the permeate chamber to reach the pressure of a surrounding atmosphere.

9. The method of claim 8 wherein applying a differential pressure across the pliable bladder comprises applying elevated pressure to the atmospheric chamber.

10. The method of claim 9 wherein applying elevated pressure to the atmospheric chamber comprises charging the atmospheric chamber via a charging valve.

11. The method of claim 9 wherein allowing the atmospheric chamber and the permeate chamber to reach the pressure of a surrounding atmosphere comprises releasing the elevated pressure from the atmospheric chamber.

12. The method of claim 11 wherein releasing the elevated pressure from the atmospheric chamber comprises opening a valve.

13. The method of claim 8 wherein applying a differential pressure across the pliable bladder comprises applying suction to the permeate chamber.

14. The method of claim 13 wherein applying suction to the permeate chamber comprises pulling on the permeate chamber with a permeate pressurizing device.

15. The method of claim 8 further comprising, prior to introducing a permeate into the purged permeate chamber, fluidly connecting the purged permeate chamber to permeate plumbing including a permeate portion of a cross flow filter.

16. The method of claim 8 further comprising, prior to introducing a permeate into the purged permeate chamber, fluidly connecting the purged permeate chamber to permeate plumbing including a permeate pressurizing device.

17. A method of producing a permeate comprising:
producing a permeate using a cross flow filter comprising a feed portion, a concentrate portion, and a permeate portion;
introducing the permeate from the permeate portion into a permeate storage apparatus comprising a pressure boundary comprising an inner wall surrounding a pliable bladder, the pliable bladder fluidly separating a permeate chamber from an atmospheric chamber which communicates with the surrounding atmosphere via an aperture in the pressure boundary such that the pressure in the atmospheric chamber remains in substantial equilibrium with the pressure of the surrounding atmosphere;
as the permeate chamber expands from introduction of permeate, allowing the atmospheric chamber to fluidly communicate with the surrounding atmosphere as it contracts to avoid generating back pressure against the permeate portion of the cross flow filter; and
pressurizing the permeate from the permeate chamber prior to delivering to a system output using a permeate pressurizing device fluidly connected between the permeate chamber and the system output.

18. The method of claim 17 further comprising delivering permeate from the permeate chamber to the system output.

19. The method of claim 18 further comprising, as the permeate chamber contracts from delivery of permeate, allowing the atmospheric chamber to fluidly communicate with the surrounding atmosphere as it expands to avoid reducing the pressure in the atmospheric chamber.
